(19) United States
(12) Patent Application Publication
(10) Pub. No.: US 2023/0409801 A1
(43) Pub. Date: Dec. 21, 2023

(54) DOCUMENT CONTENT PRESENTING METHOD AND APPARATUS, AND ELECTRONIC DEVICE

(71) Applicant: BEIJING ZITIAO NETWORK TECHNOLOGY CO., LTD., Beijing (CN)

(72) Inventor: Wei CHEN, Beijing (CN)

(21) Appl. No.: 18/241,114

(22) Filed: Aug. 31, 2023

Related U.S. Application Data
(63) Continuation of application No. PCT/CN2022/078663, filed on Mar. 1, 2022.

(30) Foreign Application Priority Data
Mar. 1, 2021 (CN) 202110227812.X

(51) Int. Cl. G06F 40/106; G06F 3/0489; G06F 3/04817; G06F 40/166; G06F 3/0484

(52) U.S. Cl. CPC G06F 40/106; G06F 3/0489; G06F 3/04817; G06F 40/166; G06F 3/0484

(57) ABSTRACT

A document presenting method includes: determining, in response to an icon display triggering operation for a first parent-child structure in document, whether the first parent-child structure include child content, where the icon display triggering operation is used to trigger display of a target folding icon; displaying the child content in the first parent-child structure and displaying the target folding icon, in response to determining that the child content is present in the first parent-child structure; and hiding the child content in the first parent-child structure in response to a triggering operation for the target folding icon.

### CROSS REFERENCE TO RELATED APPLICATION

The present application is a continuation of International Patent Application No. PCT/CN2022/078663, filed on Mar. 1, 2022, which claims priority to Chinese Patent Application No. 202110227812.X, titled “DOCUMENT PRESENTING METHOD AND DEVICE, AND ELECTRONIC DEVICE”, filed on Mar. 1, 2021, both of which are incorporated herein by reference in their entireties.

### TECHNICAL FIELD

The embodiments of the present disclosure relate to the field of computer technology, and in particular to a document presenting method, a document presenting device and an electronic device.

### BACKGROUND

In daily study or office work, documents have become one of important means for a user to view or edit information.

In related technologies, when a length of the document is long, the user has a low flexibility in viewing or editing the document because the document cannot be folded.

### SUMMARY

This summary is provided to introduce concepts in a simplified form, the concepts are described in detail in the detailed description of the embodiments below. This summary is not intended to identify key features or essential features of the claimed technical solution, nor is it intended to be used to limit the scope of the claimed technical solution.

Embodiments of the present disclosure provide a document presenting method, a document presenting device and an electronic device, which can flexibly present or fold child content in a first parent-child structure when a user views or edits document.

In a first aspect, a document presenting method is provided according to an embodiment of the present disclosure. The method includes: determining, in response to an icon display triggering operation for a first parent-child structure in document, whether the first parent-child structure include child content, where the icon display triggering operation is used to trigger display of a target folding icon; displaying the child content in the first parent-child structure and displaying the target folding icon, in response to determining that the child content is present in the first parent-child structure; hiding the child content in the first parent-child structure in response to a triggering operation for the target folding icon, wherein after the child content is hidden, the parent content corresponding to the child content is still displayed.

In a second aspect, a document presenting device is provided according to an embodiment of the present disclosure. The device includes: a determining unit configured to determine, in response to an icon display triggering operation for a first parent-child structure in document, whether the first parent-child structure include child content, where the icon display triggering operation is used to trigger display of a target folding icon; an unfolding unit configured to unfold the child content in the first parent-child structure and display the target folding icon, in response to determining that the child content is present in the first parent-child structure; and a folding unit configured to fold the child content in the first parent-child structure in response to a triggering operation for the target folding icon, wherein after the child content is hidden, the parent content corresponding to the child content is still displayed.

In a third aspect, an electronic device is provided according to an embodiment of the present disclosure. The electronic device includes one or more processors and a storage device storing one or more programs. The one or more programs, when executed by the one or more processors, cause the one or more processors to perform the document presenting method described in the above first aspect.

In a fourth aspect, a computer-readable medium is provided according to an embodiment of the present disclosure. The computer-readable medium stores a computer program. The computer program, when executed by a processor, causes the processor to perform the document presenting method described in the above first aspect.

According to the document presenting method, the document presenting device and the electronic device provided by embodiments of the present disclosure, in response to an icon display triggering operation for a first parent-child structure in document, it is determined whether the first parent-child structure include child content. Further, in response to determining that the child content is present in the first parent-child structure, the child content in the first parent-child structure is unfolded and the target folding icon is displayed. Further, in response to a triggering operation for the target folding icon, the child content in the first parent-child structure is folded. In this way, the child content in the first parent-child structure can be flexibly presented or folded when the user views or edits document, thereby improving the flexibility of the user to view or edit the document.

### BRIEF DESCRIPTION OF THE DRAWINGS

With reference to the drawings and specific embodiments below, the above and other features, advantages and aspects of embodiments of the present disclosure become more apparent. Throughout the drawings, the same or similar reference numerals indicate the same or similar elements. It should be understood that the drawings are schematic, and components and elements are unnecessarily drawn in scale.

FIG. 1 is a flowchart of a document presenting method according to an embodiment of the present disclosure;

FIG. 2 is a flowchart of a document presenting method according to another embodiment of the present disclosure;

FIG. 3 is a flowchart of a document presenting method according to another embodiment of the present disclosure;

FIG. 4 is a schematic structural diagram of a document presenting device according to an embodiment of the present disclosure;

FIG. 5 is an exemplary system architecture to which a document presenting method according to an embodiment of the present disclosure may be applied; and

FIG. 6 a schematic diagram of a basic structure of an electronic device according to an embodiment of the present disclosure.

### DETAILED DESCRIPTION OF THE EMBODIMENTS

Embodiments of the present disclosure are described in detail hereinafter with reference to the drawings. Although the drawings show some embodiments of the present disclosure, it should be understood that the present disclosure may be implemented by various embodiments and are not limited to be implemented by the embodiments clarified herein. The embodiments described in the present disclosure are intended to illustrate the present disclosure thoroughly and completely. It should be understood that the drawings and the embodiments are only schematic, and are not intended to limit the protection scope of the present disclosure.

It should be understood that, steps described in the method embodiments of the present disclosure may be performed in different orders and/or performed in parallel. In addition, the method embodiments may include additional steps and/or the shown steps may be omitted. The scope of the present disclosure is not limited thereto.

Term “including” and variations thereof adopted herein is inclusive, that is “including but not limited to”. The term “based on” means “at least partially based on”. The term “an embodiment” means “at least one embodiment”, and the term “another embodiment” means “at least one another embodiment”. The term “some embodiments” means “at least some embodiments”. Definitions of other terms are provided below.

It should be noted that, the terms “first” “second” and so on mentioned in the

present disclosure are only used to distinguish different devices, modules or units, rather than limit an order of functions performed by the device, module or unit or limit interdependence.

It should be noted that, the terms “a” and “multiple” mentioned in the present disclosure are schematic rather than restrictive, and should be understood as “one or more” by those skilled in the art, otherwise explicitly illustrated in the context.

Names of messages or information interacted between multiple device in the embodiments of the present disclosure are illustrative rather than limit the scope of the message or information.

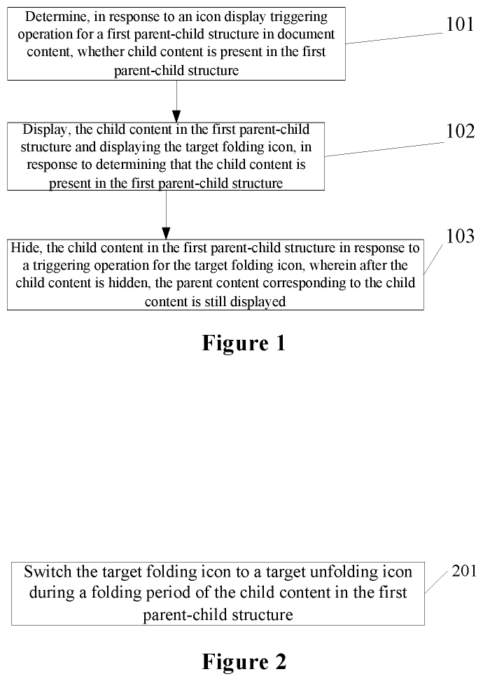

Reference is made to FIG. 1, which is a flowchart of a document presenting method according to an embodiment of the present disclosure. As shown in FIG. 1, the document presenting method includes steps 101 to 103.

Step 101, determine, in response to an icon display triggering operation for a first parent-child structure in document, whether the first parent-child structure include child content.

In this embodiment, the document of a document may include the first parent-child structure.

The above document may be an online document for a user to operate online.

The parent-child structure may be a structure for presenting content in the document. Usually, the document may include at least one parent-child structure. In practice, according to specific needs, the user may present some content in the document in form of a parent-child structure.

The parent-child structure may include parent content and child content. The parent content may be upper-level content of the child content. The child content in the parent-child structure may be unfolded or folded. It may be understood that, after the child content is unfolded, both the parent content and the child content in the parent-child structure may be presented in the document. After the child content is folded, the parent content in the parent-child structure may be presented in the document.

Optionally, the parent content in the parent-child structure includes at least one of content presented as a title, content presented as an unordered list, content presented as an ordered list and content presented as a taskbar. Apparently, the parent content in the parent-child structure may also include other content, which will not be listed here.

In some scenarios, the child content in the parent-child structure may include content presented in any form. For example, the child content in the parent-child structure may include a picture.

In this embodiment, the user may perform the icon display triggering operation for the first parent-child structure.

The icon display triggering operation is used to trigger a target folding icon. The folding icon may be various icons for folding the child content in the parent-child structure. For example, the folding icon may be an arrow icon “▾” pointing from top to bottom. It may be understood that the target folding icon may be an icon for hiding the child content in the first parent-child structure.

Optionally, the icon display triggering operation includes hovering a cursor on a row where the first parent-child structure is located.

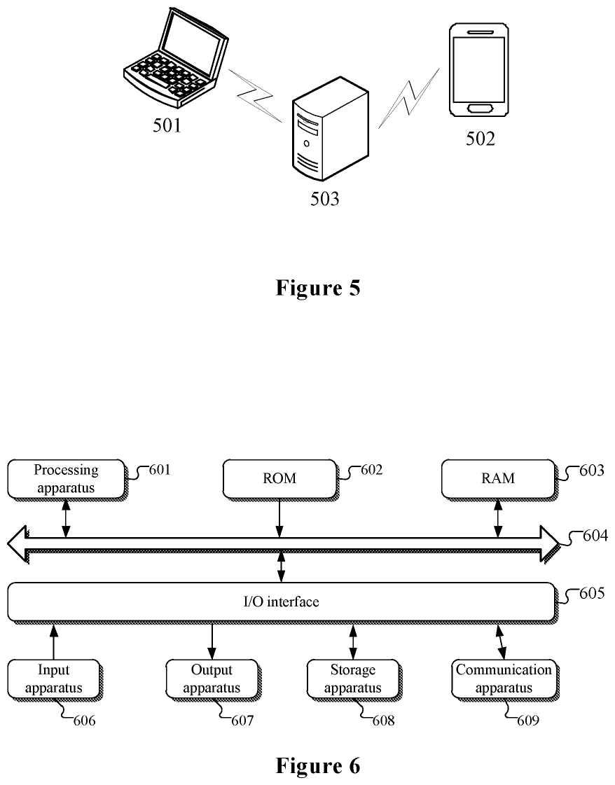

In this embodiment, in response to the icon display triggering operation performed by the user for the first parent-child structure, an execution subject of the document presenting method (for example, the terminal device 501 or the terminal device 502 shown in FIG. 5) may determine whether the child content is present in the first parent-child structure.

Step 102, unfold the child content in the first parent-child structure and display the target folding icon, in response to determining that the child content is present in the first parent-child structure.

In this embodiment, in response to determining that the child content is present in the first parent-child structure, the execution subject may unfold the child content in the first parent-child structure and display the target folding icon.

Step 103, fold the child content in the first parent-child structure in response to a

triggering operation for the target folding icon, wherein after the child content is hidden, the parent content corresponding to the child content is still displayed.

In this embodiment, in response to the triggering operation performed by the user for the target folding icon, the execution subject may fold the child content in the first parent-child structure.

It can be seen that the child content is present in the first parent-child structure and the child content is folded. If the user performs the icon display triggering operation for the first parent-child structure, the child content in the first parent-child structure may be unfolded and the target folding icon may be displayed. Further, if the user performs the triggering operation for the target folding icon, the child content in the first parent-child structure may be folded.

In this way, the child content in the first parent-child structure can be flexibly presented or folded when the user views or edits document, thereby improving the flexibility of the user to view or edit the document.

In some embodiments, the above execution subject may also perform a step included in a process shown in FIG. 2. The process includes the step 201.

Step 201, switch the target folding icon to a target unfolding icon during a folding period of the child content in the first parent-child structure.

The folding period of the child content may be a time period from a time instant that the child content is folded to a time instant that the child content is unfolded at next time.

The unfolding icon may be various icons for unfolding the child content in the parent-child structure. For example, the unfolding icon may be an arrow icon “ [symbol] ” pointing from left to right. It may be understood that the target unfolding icon may be an icon for displaying the child content in the first parent-child structure.

Thus, during the folding period of the child content in the first parent-child structure,

the target unfolding icon is displayed to prompt the user that the child content is present in the first parent-child structure.

Optionally, in response to a triggering operation for the target unfolding icon, the child content in the first parent-child structure may be unfolded, and the target unfolding icon may be switched to the target folding icon.

In some embodiments, before performing the above step 103, the above execution subject may also perform the following steps.

Specifically, the display of the target folding icon is cancelled in response to end of the icon display triggering operation.

Thus, when the user performs the icon display triggering operation for the first

parent-child structure, the target folding icon may be displayed. After the icon display triggering operation performed by the user for the first parent-child structure ends, the display of the target folding icon may be cancelled.

In some embodiments, after performing the above step 103, the above execution subject may also perform the following steps.

Specifically, after the child content in the first parent-child structure is folded, positions of parent content and the folded child content of the first parent-child structure in the document are moved based on a move operation of the parent content in the first parent-child structure.

The move operation may be an operation for moving the parent-child structure, or an operation for moving the parent content or the child content in the parent-child structure. It should be noted that the move operation may be implemented in various ways, which are not specifically limited here.

Therefore, after the child content in the first parent-child structure is folded, if the

user performs the move operation for the parent content in the first parent-child structure, the positions of the parent content and the folded child content of the first parent-child structure in the document may be moved simultaneously.

In practice, after the child content is folded, the first parent-child structure occupies a smaller area in the document. In this case, by operating the parent content with a smaller occupied area, the positions of the parent content and the child content of the first parent-child structure in the document may be moved simultaneously. Therefore, it is more convenient to move the position of the first parent-child structure in the document.

In some embodiments, after performing the above step 103, the above execution subject may also perform the following steps.

Specifically, after the child content in the first parent-child structure is folded, in response to determining that a cursor is located at a predetermined position on a row where parent content in the first parent-child structure is located and in response to a triggering operation for a first predetermined key on a keyboard, performing at least one of: displaying the child content in the first parent-child structure; and inserting a blank row below the row where the parent content in the first parent-child structure is located.

Here, the predetermined position may be a position in front of or behind the parent content in the first parent-child structure. Apparently, the aforementioned predetermined position may also be other positions in the row where the parent content in the first parent-child structure is located, which is not specifically limited here.

The first predetermined key may be, for example, an “enter” key on a keyboard. Apparently, the first predetermined key may also be other keys on the keyboard, which is not specifically limited here.

The blank row may be a row that does not contain document.

Thus, after the child content in the first parent-child structure is folded, the user operates the first predetermined key on the keyboard to: unfold the child content in the first parent-child structure; and/or insert a blank row below the row where the parent content in the first parent-child structure is located.

It may be understood that, a spacing between the parent content and the child content presented in the first parent-child structure may be adjusted by displaying the child content in the first parent-child structure and inserting the blank row below the row where the parent content in the first parent-child structure is located. A spacing between the first parent-child structure and other content in the document may be adjusted by inserting the blank row below the row where the parent content in the first parent-child structure is located.

In some embodiments, the above execution subject may also perform the following steps.

Specifically, in response to folding child content in a second parent-child structure to be pasted, the second parent-child structure is pasted into the document in a form of the child content being unfolded.

The second parent-child structure is copied in response to a copy operation for

parent content in the second parent-child structure.

The second parent-child structure may be a parent-child structure to be pasted into the above document. In practice, the second parent-child structure may be a parent-child structure copied from the above document, or a parent-child structure copied from other documents.

It may be understood that after being pasted into the document, the parent content in the second parent-child structure is presented, and the child content in the second parent-child structure is folded.

Thus, after the child content in the second parent-child structure is folded, the parent content and the folded child content in the second parent-child structure are copied by performing the copy operation for the parent content in the second parent-child structure. Further, after the user performs a paste operation, the second parent-child structure is pasted into the above document in the form of the child content being folded.

In practice, after the child content is folded, the second parent-child structure occupies a smaller area in the document. Therefore, after the child content in the second parent-child structure is folded, it is only necessary to perform a copy operation for the second parent-child structure occupying a smaller area to realize the copying of the second parent-child structure. Similarly, pasting the second parent-child structure into the document in the form of the child content being folded is beneficial for the user to view the second parent-child structure more intuitively.

In some embodiments, the document includes first content and second content in adjacent rows, and the row where the first content is located is in front of the row where the second content is located.

In this case, the above execution subject may also perform the following steps.

Specifically, in response to determining that a cursor is located at a predetermined position in the row where the first content is located and in response to a triggering operation for a second predetermined key on a keyboard, a target parent-child structure is formed by taking the first content as parent content and taking the second content as child content.

Here, the predetermined position may be a position in front of or behind the first content. Apparently, the aforementioned predetermined position may also be other positions on the line where the first content is located, which is not specifically limited here.

The second predetermined key may be, for example, the “Tab” key on the keyboard. Apparently, the second predetermined key may also be other keys on the keyboard, which is not specifically limited here.

Thus, by operating the second predetermined key on the keyboard, the target

parent-child structure is formed based on the first content and the second content arranged in adjacent rows.

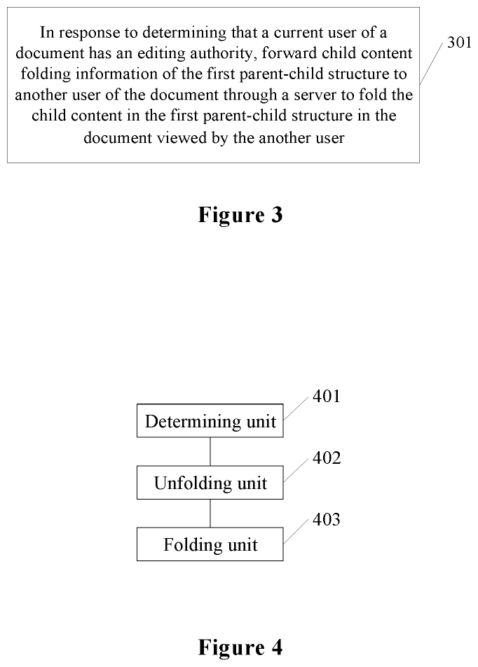

In some embodiments, the above execution subject may also perform a step in a process shown in FIG. 3. The process includes step 301.

Step 301, in response to determining that a current user of a document has an editing authority, forward child content folding information of the first parent-child structure to another user of the document through a server (for example, the server 503 shown in FIG. 5) to fold the child content in the first parent-child structure in the document viewed by the another user.

The editing authority may be an authority of editing the document.

The child content folding information may be information for representing the folding of the child content in the first parent-child structure. In practice, the child content folding information may be expressed in various forms, which are not specifically limited here.

After receiving the child content folding information forwarded by the server, the terminal of another user (for example, the terminal device 501 or terminal device 502 shown in FIG. 5) may fold the child content contained in the first parent-child structure in the above document.

Thus, if the user with the editing authority folds the child content in the first parent-child structure, the child content in the first parent-child structure in the document viewed by the another user may be folded synchronously.

In some embodiments, the terminal of the another user folds the child content in the first parent-child structure in the document by any of the following manners.

Manner 1

Specifically, the child content in the first parent-child structure is folded in real time in the document in response to receiving the child content folding information.

In this case, after the current user folds the child content in the first parent-child structure, the child content in the first parent-child structure may be folded in real time in the document viewed by the another user.

Manner 2

Specifically, after receiving the child content folding information, the child content in the first parent-child structure is folded in the document in response to determining that the document meets a content refresh condition.

The content refresh condition may be a condition for refreshing the document. Optionally, the content refresh condition includes at least one of detecting a triggering operation for a refresh control, and detecting an operation of opening the document.

In this case, after the current user folds the child content in the first parent-child structure, the child content in the first parent-child structure is not folded in real time in the above-mentioned document viewed by another user. The child content in the first parent-child structure is folded in response to determining that the document meets the content refresh condition.

Manner 3

A first step is to present a prompt interface after receiving the child content folding information.

The prompt interface includes a confirmation folding control.

The confirmation folding control is a control for hiding the child content in the first parent-child structure.

A second step is to fold the child content in the first parent-child structure in the document in response to a triggering operation for the confirmation folding control.

In this case, after the current user folds the child content in the first parent-child structure, the child content in the first parent-child structure is not folded in real time in the document viewed by another user. Instead, the prompt interface is used to prompt the another user whether to fold the child content in the first parent-child structure. Further, when the another user performs a triggering operation for the confirmation folding control in the prompt interface, the child content in the first parent-child structure is then folded.

In some embodiments, the terminal of another user may perform the following steps.

Specifically, after receiving the child content folding information, in the document viewed by the another user, in response to determining that the first parent-child structure is in an editing process for the child content or an editing process for child content comment information, the child content in the first parent-child structure refuses to be folded in real time.

The first parent-child structure being in the editing process for the child content means that another user is editing the child content in the first parent-child structure. The first parent-child structure being in the editing process for child content comment information means that another user is editing comment information of the child content in the first parent-child structure.

In practice, when the child content in the first parent-child structure is presented, the user may edit the child content in the first parent-child structure or edit the comment information of the child content in the first parent-child structure.

Thus, after the current user folds the child content in the first parent-child structure, if another user viewing the above document is editing the child content in the first parent-child structure or the comment information of the child content in the first parent-child structure, other users, the terminal of the another user refuses to fold the child content in the first parent-child structure in real time.

In some embodiments, the above execution subject may also perform the following steps.

Specifically, in response to determining that a current user of a document has a viewing authority, it is refused to forward child content folding information of the first parent-child structure to another user of the document.

The viewing authority may be an authority of viewing the document. In practice, a user who only has the viewing authority cannot edit the document of the document.

Therefore, when the current user only has the viewing authority, if the current user folds the child content in the first parent-child structure, the folding of the child content in the first parent-child structure only takes effect in the document that the current user views, and is not synchronized to the above document that other users view.

In some embodiments, the above execution subject may also perform the following steps.

Specifically, in response to determining that the document meets a content refresh condition and in response to receiving child content operation information forwarded by a server, the child content in the first parent-child structure is unfolded or folded based on the child content operation information.

The child content operation information indicates that another user with an editing authority recently unfolds or folds the child content in the first parent-child structure.

In practice, recently unfolding or hiding the child content in the first parent-child structure may be another user with the editing authority recently unfolds or folds the child content in the first parent-child structure before the content refresh condition is met.

Thus, when the current user only has the viewing authority, the current user folding or displaying the child content in the first parent-child structure in the document only takes effect before the content refresh condition is met. After the content refresh condition is met, in the above-mentioned document viewed by the current user, the child content in the first parent-child structure is unfolded or folded based on the latest operation performed by the another user with the editing authority.

Reference is made to FIG. 4, as an implementation of the methods described above, the present disclosure provides an embodiment of a document presenting device, the device embodiment corresponds to the display method embodiment shown in FIG. 1, and the device may specifically be used in various electronic devices.

As shown in FIG. 4, the document presenting device according to the embodiment

includes: a determining unit 401, an unfolding unit 402 and a folding unit 403. The determining unit 401 is configured to determine, in response to an icon display triggering operation for a first parent-child structure in document, whether the first parent-child structure include child content, where the icon display triggering operation is used to trigger display of a target folding icon. The unfolding unit 402 is configured to unfold the child content in the first parent-child structure and display the target folding icon, in response to determining that the child content is present in the first parent-child structure. The folding unit 403 is configured to fold the child content in the first parent-child structure in response to a triggering operation for the target folding icon, wherein after the child content is hidden, the parent content corresponding to the child content is still displayed.

In this embodiment, the specific processing of the determining unit 401, the unfolding unit 402 and the folding unit 403 of the document presenting device and the technical effects brought by the units may refer to the relevant descriptions of steps 101, 102 and 103 in the corresponding embodiment of FIG. 1 respectively, which will is not repeated here.

In an embodiment, the document presenting device further includes a switching unit (not shown in the drawing) configured to switch the target folding icon to a target unfolding icon during a folding period of the child content in the first parent-child structure.

In an embodiment, the icon display triggering operation includes hovering a cursor on a row where the first parent-child structure is located.

In an embodiment, the document presenting device further includes a cancelling unit (not shown in the drawing) configured to cancel the display of the target folding icon in response to end of the icon display triggering operation.

In an embodiment, the document presenting device further includes a moving unit (not shown in the drawing) configured to: after the child content in the first parent-child structure is folded, move, based on a move operation of parent content in the first parent-child structure, positions of the parent content and the folded child content of the first parent-child structure in the document.

In an embodiment, the document presenting device further includes a performing unit (not shown in the drawing) configured to: after the child content in the first parent-child structure is folded, in response to determining that a cursor is located at a predetermined position on a row where parent content in the first parent-child structure is located and in response to a triggering operation for a first predetermined key on a keyboard, perform at least one of: displaying the child content in the first parent-child structure; and inserting a blank row below the row where the parent content in the first parent-child structure is located.

In an embodiment, the document presenting device further includes a pasting unit (not shown in the drawing) configured to paste, in response to folding child content in a second parent-child structure to be pasted, the second parent-child structure into the document in a form of the child content being unfolded, where the second parent-child structure is copied in response to a copy operation for parent content in the second parent-child structure.

In an embodiment, the document includes first content and second content in adjacent rows, and the row where the first content is located is in front of the row where the second content is located. The document presenting device further includes a forming unit (not shown in the drawing) configured to form a target parent-child structure by taking the first content as parent content and taking the second content as child content, in response to determining that a cursor is located at a predetermined position in the row where the first content is located and in response to a triggering operation for a second predetermined key on a keyboard.

In an embodiment, the document presenting device further includes a forwarding unit (not shown in the drawing) configured to, in response to determining that a current user of a document has an editing authority, forward child content folding information of the first parent-child structure to another user of the document through a server, to fold the child content in the first parent-child structure in the document viewed by the another user.

In an embodiment, the child content in the first parent-child structure in the document viewed by the another user is folded by: hiding the child content in the first parent-child structure in the document in real time in response to receiving the child content folding information; or after receiving the child content folding information, hiding the child content in the first parent-child structure in the document in response to determining that the document meets a content refresh condition; or presenting a prompt interface after receiving the child content folding information, where the prompt interface includes a confirmation folding control, and hiding the child content in the first parent-child structure in the document in response to a triggering operation for the confirmation folding control.

In an embodiment, after receiving the child content folding information, in the document viewed by the another user, in response to determining that the first parent-child structure is in an editing process for the child content or an editing process for child content comment information, the child content in the first parent-child structure refuses to be folded in real time.

In an embodiment, the document presenting device further includes a refusing unit (not shown in the drawing) configured to, in response to determining that a current user of a document has a viewing authority, refuse to forward child content folding information of the first parent-child structure to another user of the document.

In an embodiment, the document presenting device further includes a refresh unit (not shown in the drawing) configured to, in response to determining that the document meets a content refresh condition and in response to receiving child content operation information forwarded by a server, unfold or fold the child content in the first parent-child structure based on the child content operation information, where the child content operation information indicates that another user with an editing authority recently unfolds or folds the child content in the first parent-child structure.

In an embodiment, parent content in the parent-child structure includes at least one of content presented as a title, content presented as an unordered list, content presented as an ordered list and content presented as a taskbar.

Reference is made to FIG. 5, which is an exemplary system architecture to which a document presenting method according to an embodiment of the present disclosure may be applied.

As shown in FIG. 5, the system architecture may include a terminal device 501, a terminal device 502 and a server 503. In practice, the terminal device 501 and the server 503, or the terminal device 502 and the server 503, may interact through a network. The network may include various connection types such as wires, wireless communication links, or fiber optic cables.

Various client applications may be installed on the terminal device 501 and the terminal device 502. For example, document editing applications may be installed.

In some scenarios, in response to an icon display triggering operation for a first parent-child structure in document, the terminal device 501 or the terminal device 502 may determine whether the first parent-child structure include child content. Further, in response to determining that the child content is present in the first parent-child structure, the terminal device 501 or the terminal device 502 may unfold the child content in the first parent-child structure and display the target folding icon. Further, in response to a triggering operation for the target folding icon, the terminal device 501 or the terminal device 502 may fold the child content in the first parent-child structure.

The terminal devices 501, 502 may be hardware or software. When the terminal devices 501, 502 are hardware, they may be various electronic devices that have a display screen and support information interaction, including but not limited to smart phones, tablet computers, laptops and desktops, etc. When the terminal devices 501, 502 are software, they may be installed in the electronic devices listed above. They may be implemented as multiple software or software modules or may be implemented as a single software or software module, which is not limited here.

The server 504 may be a server that provides various services. In some scenarios, the server 504 may forward child content operation information between the terminal device 501 and the terminal device 502. For example, a user views a document on the terminal device 501, and a user B views the document on the terminal device 502. After the user A unfolds or folds the child content contained in the parent-child structure M in the document, the terminal device 501 may forward the child content operation information to the terminal device 502 through the server 504. Further, the terminal device 502 may unfold or fold the child content contained in the parent-child structure M in the document viewed by the user B based on the received child content operation information.

The server 504 may be hardware or software. When the server 504 is hardware, it may be implemented as a distributed server cluster composed of multiple servers, or may be implemented as a single server. When the server 504 is software, it may be implemented as multiple software or software modules (e.g., multiple software or software modules for providing distributed services), or may be implemented as a single software or software module. There is no specific limitation here.

It should be noted that the document presenting method provided by the embodiments of the present disclosure may be executed by the terminal device 501 or the terminal device 502, and correspondingly, the document presenting device may be provided in the terminal device 501 or the terminal device 502.

It should be understood that the numbers of terminal devices, networks and servers in FIG. 5 are merely illustrative. There may be any number of terminal devices, networks and servers according to implementation needs.

Reference is made to FIG. 6 which shows a schematic structural diagram of an electronic device (such as the terminal device in FIG. 5) for implementing the embodiments of the present disclosure. The terminal device in the embodiments of the present disclosure may include but not limited to mobile terminals such as a mobile phone, a notebook computer, a digital broadcast receiver, a personal digital assistance (PDA), a tablet computer (PAD), a portable multi-media player (PMP) and a vehicle terminal (such as a vehicle navigation terminal); and fixed terminals such as digital TV and a desktop computer. The electronic device shown in FIG. 6 is schematic, and is not intended to limit functions and scope of the embodiments of the present disclosure.

As shown in FIG. 6, the electronic device may include a processing device (such as a central processor and a graphic processor) 601. The processing device may perform various appropriate actions and processing by executing programs stored in a read-only memory (ROM) 602 or programs uploaded from a storage device 608 to a random access memory (RAM) 603. Various programs and data required for operations of the electronic device are also stored in the RAM 603. The processing device 601, the ROM 602 and the RAM 603 are connected to each other through the bus 604. An input/output (I/O) interface 605 is also connected to the bus 604.

Generally, the following components are connected to the I/O interface 605: an input device 606 such as a touch screen, a touch panel, a keyboard, a mouse, a camera, a microphone, an accelerometer, and gyroscope; an output device 607 such as a liquid crystal display (LCD), a loudspeaker and a vibrator; a storage device 608 such as a magnetic tape and a hard disk; and a communication device 609. The communication device 609 may allow the electronic device to communicate with other device in a wired or wireless manner to exchange data. Although FIG. 6 shows the electronic device provided with various device, it should be understood that not all shown device are necessary. More or fewer device may alternatively be implemented or provided. Each block shown in FIG. 6 may represent one device, or may represent multiple device as required.

According to the embodiments of the present disclosure, a process described in the flowchart may be implemented by computer software programs. For example, according to an embodiment of the present disclosure, a computer program product including computer program carried on a non-transient computer readable medium is provided. The computer program includes program codes for performing the method shown in the flowchart. In such embodiment, the computer program may be downloaded and installed from the network through the communication device 609, installed from the storage device 608 or installed from the ROM 602. The computer program is executed by the processing device 601 to perform functions defined in the methods described in the embodiments of the present disclosure.

It should be noted that, the computer readable medium described in the embodiments of the present disclosure may be a computer readable signal medium, a computer readable storage medium or any combination thereof. The computer readable storage medium may include but not limited to a system, an device or a device in an electric, magnetic, optical, electromagnetic, infrared or a semiconductor form, or any combination thereof. The computer readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof In some embodiments of the present disclosure, the computer readable storage medium may be a tangible medium including or storing programs. The programs may be used by an instruction execution system, device or device, or may be used in combination with the instruction execution system, device or device. In some embodiments of the present disclosure, a computer readable signal medium may include a data signal in a baseband or propagated as a part of carrier. The computer readable signal medium carries computer readable program codes. The propagated data signal may include but not limited to an electromagnetic signal, an optical signal or any combination thereof. The computer readable signal medium may be any computer readable medium other than the computer readable storage medium. The computer readable signal medium may send, propagate or transmit programs used by the instruction execution system, device or device or the programs used in combination with the instruction execution system, device or device. The program code included in the computer readable medium may be transmitted via any appropriate medium, including but not limited to an electric wire, an optical fiber, radio frequency (RF) or any appropriate combination thereof.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example the internet), a peer-to-peer network (for example ad hoc peer-to-peer network), and any known network or network to be developed.

The computer readable storage medium may be included in the electronic device, or the computer readable storage medium may be independent from the electronic device, i.e., not being installed in the electronic device. The computer readable medium carries one or more programs. The one or more programs, when executed by the electronic device, cause the electronic device to: determine, in response to an icon display triggering operation for a first parent-child structure in document, whether the first parent-child structure include child content, where the icon display triggering operation is used to trigger display of a target folding icon; unfold the child content in the first parent-child structure and display the target folding icon, in response to determining that the child content is present in the first parent-child structure; and fold the child content in the first parent-child structure in response to a triggering operation for the target folding icon.

Computer program codes for performing operations of the present disclosure may be written by using one or more program design language or any combination. The program design language includes but not limited to object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowcharts and block diagrams shown in the drawings show a system architecture, function and operation which may be implemented by the system, method and computer program product according to the embodiments of the present disclosure. Each block in the flowcharts or the block diagram may represent a part of a module, a program section or codes including executable instructions for implementing specified logic functions. It should be noted that, in alternative embodiment, functions denoted in the blocks may be performed in an order different from the order denoted in the drawing. For example, operations in two blocks connected successively may be performed in parallel, or may be performed in an opposite order, depending on the involved function. It should be noted that, each block in the block diagrams and/or flowcharts, and a combination of blocks in the block diagrams and/or flowcharts may be implemented by a dedicated hardware system for performing specified functions or operations, or may be implemented by a combination of dedicated hardware and computer instructions.

Units involved in the embodiments of the present disclosure may be implemented by software or hardware. Names of the units do not limit the units in a certain case. For example, the folding unit may also be described as “a unit for hiding the child content in the first parent-child structure in response to a triggering operation for the target folding icon”.

The functions described above may be partially performed by one or more hardware logic components. For example, non-restrictively, exemplary types of hardware logic components that may be used include: a field programmable gate array (FPGA), an application specific integrated circuit (ASIC), an application specific standard product (ASSP), a system on chip (SOC), a complex programmable logic device (CPLD) and so on.

In the context of the present disclosure, the machine readable medium may be a

tangible medium including or storing programs. The programs may be used by an instruction execution system, device or device, or may be used in combination with the instruction execution system, device or device. The machine readable medium may be a machine readable signal medium or a machine readable storage medium. The machine readable medium may include but not limited to a system, an device or a device in an electric, magnetic, optical, electromagnetic, infrared or a semiconductor form, or any combination thereof. The machine readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof.

The preferred embodiments and the technical principles of the present disclosure are described above. It should be understood by those skilled in the art that, the protection scope of the present disclosure is not limited to the technical solutions formed by specific combination of the above technical features, and other technical solutions formed by random combinations of the above technical features or equivalent features without departing from the concept of the present disclosure also fall within the protection scope of the present disclosure, for example the technical solution formed by replacement between the above technical features and technical features with similar functions disclosed (not limited) in the present disclosure.

Although the operations are described in a specific order, the operations are unnecessarily to be performed in the specific order or in a chronological order. In a certain environment, a multi-task and parallel processing may be beneficial. Although specific details are described above, the details should not be understood as restriction to the scope of the present disclosure. Some features described in the context of different embodiments may be combined in one embodiment. Alternatively, the features described in the context of one embodiment may be implemented in multiple embodiments independently or in any appropriate sub-combination.

The subject matter is described by language specific to the structure feature and/or method logic, it should be understood that the subject matter defined in the appended claims is not limited to the specific features or actions described above. The specific features and actions are only schematic implementation of the claims.

1. A method of presenting document content, comprising:
determining, in response to an icon display triggering operation for a first parent-child structure in document, whether the first parent-child structure include child content, wherein the icon display triggering operation is used to trigger display of a target folding icon;
displaying, the child content in the first parent-child structure and displaying the target folding icon, in response to determining that the child content is present in the first parent-child structure; and
hiding, the child content in the first parent-child structure in response to a triggering operation for the target folding icon, wherein after the child content is hidden, the parent content corresponding to the child content is still displayed.

2. The method according to claim 1, further comprising:
switching the target folding icon to a target unfolding icon during a folding period of the child content in the first parent-child structure; or
after the child content in the first parent-child structure is folded, moving, based on a move operation of parent content in the first parent-child structure, positions of the parent content and the folded child content of the first parent-child structure in the document.

3. The method according to claim 1, wherein the icon display triggering operation comprises hovering a cursor on a row where the first parent-child structure is located.

4. The method according to claim 1, wherein before hiding the child content in the first parent-child structure in response to the triggering operation for the target folding icon, the method further comprises:
cancelling the display of the target folding icon in response to end of the icon display triggering operation.

5. The method according to claim 1, further comprising:
after the child content in the first parent-child structure is folded, in response to determining that a cursor is located at a predetermined position on a row where parent content in the first parent-child structure is located and in response to a triggering operation for a first predetermined key on a keyboard, performing at least one of displaying the child content in the first parent-child structure or inserting a blank row below the row where the parent content in the first parent-child structure is located; or
pasting, in response to folding child content in a second parent-child structure to be pasted, the second parent-child structure into the document in a form of the child content being unfolded, wherein the second parent-child structure is copied in response to a copy operation for parent content in the second parent-child structure.

6. The method according to claim 1, wherein the document comprises first content and second content in adjacent rows, and the row where the first content is located is in front of the row where the second content is located; and the method further comprises:
forming a target parent-child structure by taking the first content as parent content and taking the second content as child content, in response to determining that a cursor is located at a predetermined position in the row where the first content is located and in response to a triggering operation for a second predetermined key on a keyboard.

7. The method according to claim 1, further comprising:
in response to determining that a current user of a document has an editing authority, forwarding child content folding information of the first parent-child structure to another user of the document through a server, to fold the child content in the first parent-child structure in the document viewed by the another user.

8. The method according to claim 7, wherein after receiving the child content folding information, in the document viewed by the another user, in response to determining that the first parent-child structure is in an editing process for the child content or an editing process for child content comment information, the child content in the first parent-child structure refuses to be folded in real time; or
wherein the child content in the first parent-child structure in the document viewed by the another user is folded by: hiding the child content in the first parent-child structure in the document in real time in response to receiving the child content folding information; or
after receiving the child content folding information, hiding the child content in the first parent-child structure in the document in response to determining that the document meets a content refresh condition; or
presenting a prompt interface after receiving the child content folding information, wherein the prompt interface comprises a confirmation folding control, and hiding the child content in the first parent-child structure in the document in response to a triggering operation for the confirmation folding control.

9. The method according to claim 1, further comprising:
in response to determining that a current user of a document has a viewing authority, refusing to forward child content folding information of the first parent-child structure to another user of the document.

10. The method according to claim 9, further comprising:
in response to determining that the document meets a content refresh condition and in response to receiving child content operation information forwarded by a server, unfolding or hiding the child content in the first parent-child structure based on the child content operation information, wherein the child content operation information indicates that another user with an editing authority recently unfolds or folds the child content in the first parent-child structure.

11. A computing device of presenting document content, comprising:
at least one processor; and
at least one memory communicatively coupled to the at least one processor and storing instructions that upon execution by the at least one processor cause the device to:
determine, in response to an icon display triggering operation for a first parent-child structure in document, whether the first parent-child structure include child content, wherein the icon display triggering operation is used to trigger display of a target folding icon;
displaying the child content in the first parent-child structure and display the target folding icon, in response to determining that the child content is present in the first parent-child structure; and
hiding the child content in the first parent-child structure in response to a triggering operation for the target folding icon, wherein after the child content is hidden, the parent content corresponding to the child content is still displayed.

12. A computer-readable non-transitory medium, bearing computer-readable instructions that upon execution on a computing device cause the computing device at least to:
determine, in response to an icon display triggering operation for a first parent-child structure in document, whether the first parent-child structure include child content, wherein the icon display triggering operation is used to trigger display of a target folding icon;
display the child content in the first parent-child structure and displaying the target folding icon, in response to determining that the child content is present in the first parent-child structure; and
hide the child content in the first parent-child structure in response to a triggering operation for the target folding icon, wherein after the child content is hidden, the parent content corresponding to the child content is still displayed.

13. The computing device of claim 11, the at least one memory further storing instructions that upon execution by the at least one processor cause the device to:
switch the target folding icon to a target unfolding icon during a folding period of the child content in the first parent-child structure;
after the child content in the first parent-child structure is folded, move, based on a move operation of parent content in the first parent-child structure, positions of the parent content and the folded child content of the first parent-child structure in the document.

14. The computing device of claim 11, the at least one memory further storing instructions that upon execution by the at least one processor cause the device to:
wherein the icon display triggering operation comprises hovering a cursor on a row where the first parent-child structure is located.

15. The computing device of claim 11, the at least one memory further storing instructions that upon execution by the at least one processor cause the device to:
cancel the display of the target folding icon in response to end of the icon display triggering operation.

16. The computing device of claim 11, the at least one memory further storing instructions that upon execution by the at least one processor cause the device to perform:
after the child content in the first parent-child structure is folded, in response to determining that a cursor is located at a predetermined position on a row where parent content in the first parent-child structure is located and in response to a triggering operation for a first predetermined key on a keyboard, performing at least one of unfolding the child content in the first parent-child structure, or inserting a blank row below the row where the parent content in the first parent-child structure is located; or
pasting, in response to folding child content in a second parent-child structure to be pasted, the second parent-child structure into the document in a form of the child content being unfolded, wherein the second parent-child structure is copied in response to a copy operation for parent content in the second parent-child structure.

17. The computing device of claim 11, wherein the document comprises first content and second content in adjacent rows, and the row where the first content is located is in front of the row where the second content is located, and wherein the at least one memory further stores instructions that upon execution by the at least one processor cause the device to:
form a target parent-child structure by taking the first content as parent content and taking the second content as child content, in response to determining that a cursor is located at a predetermined position in the row where the first content is located and in response to a triggering operation for a second predetermined key on a keyboard.

18. The computing device of claim 11, the at least one memory further storing instructions that upon execution by the at least one processor cause the device to:
in response to determining that a current user of a document has an editing authority, forward child content folding information of the first parent-child structure to another user of the document through a server, to fold the child content in the first parent-child structure in the document viewed by the another user.

19. The computing device of claim 18, wherein after receiving the child content folding information, in the document viewed by the another user, in response to determining that the first parent-child structure is in an editing process for the child content or an editing process for child content comment information, the child content in the first parent-child structure refuses to be folded in real time; or
wherein the child content in the first parent-child structure in the document viewed by the another user is folded by: hiding the child content in the first parent-child structure in the document in real time in response to receiving the child content folding information; or
after receiving the child content folding information, hiding the child content in the first parent-child structure in the document in response to determining that the document meets a content refresh condition; or
presenting a prompt interface after receiving the child content folding information, wherein the prompt interface comprises a confirmation folding control, and hiding the child content in the first parent-child structure in the document in response to a triggering operation for the confirmation folding control.

20. The computing device of claim 11, the at least one memory further storing instructions that upon execution by the at least one processor cause the device to:
in response to determining that a current user of a document has a viewing authority, refuse to forward child content folding information of the first parent-child structure to another user of the document.

21. The computing device of claim 20, the at least one memory further storing instructions that upon execution by the at least one processor cause the device to:
in response to determining that the document meets a content refresh condition and in response to receiving child content operation information forwarded by a server, unfold or fold the child content in the first parent-child structure based on the child content operation information, wherein the child content operation information indicates that another user with an editing authority recently unfolds or folds the child content in the first parent-child structure.
